(19) United States
(12) Patent Application Publication
(10) Pub. No.: US 2024/0182259 A1
(43) Pub. Date: Jun. 6, 2024

(54) RECORDING-MEDIUM PROCESSING APPARATUS AND IMAGE FORMING SYSTEM

(71) Applicant: FUJIFILM Business Innovation Corp., Tokyo (JP)

(72) Inventors: Takayuki FUKAMACHI, Kanagawa (JP); Eri FUKUI, Kanagawa (JP); Koji KAWANO, Kanagawa (JP); Yuki MIZUNO, Kanagawa (JP); Ryota IZUMI, Kanagawa (JP); Takashi OGINO, Kanagawa (JP); Imei YANASE, Kanagawa (JP); Kazuto HAYASHI, Kanagawa (JP)

(73) Assignee: FUJIFILM Business Innovation Corp., Tokyo (JP)

(21) Appl. No.: 18/301,579

(22) Filed: Apr. 17, 2023

(30) Foreign Application Priority Data
Dec. 2, 2022 (JP) 2022-193572

(51) Int. Cl. B65H 45/18; B41J 11/00; G03G 15/00

(52) U.S. Cl. CPC B65H 45/18; B41J 11/00; G03G 15/6529; B65H 2701/1829

(57) ABSTRACT

A recording-medium processing apparatus includes: a mobile body that supports a to-be-pressed portion against which a first end portion of a recording medium that is to undergo a folding process is pressed, the mobile body allowing the to-be-pressed portion to move relative to the mobile body; and a moving mechanism that includes a driving source, and moves the to-be-pressed portion relative to the mobile body.

### CROSS-REFERENCE TO RELATED APPLICATIONS

This application is based on and claims priority under 35 USC 119 from Japanese Patent Application No. 2022-193572 filed Dec. 2, 2022.

### BACKGROUND

### (i) Technical Field

The present disclosure relates to a recording-medium processing apparatus and an image forming system.

### (ii) Related Art

Japanese Unexamined Patent Application Publication No. 2019-45784 discloses an image processing device that includes a folder and an image reader. The folder folds an adjustment sheet having an adjustment pattern along a preset reference folding position across the adjustment pattern. The image reader reads an image of the adjustment pattern on the adjustment sheet while the adjustment sheet folded by the folder is unfolded.

Japanese Unexamined Patent Application Publication No. 2005-89100 discloses a process of controlling a folding operation of a folder and a thrusting operation of a thrusting member in accordance with the magnitude of friction that occurs between sheets forming a bundle when the sheet bundle is to be folded.

### SUMMARY

A device that processes recording media may perform a process of folding recording media.

When the device has a structure that is non-adjustable for the folding process or uneasily prepared for adjustment for the folding process, the device may fail to make adjustment for the folding process or may consume time for adjustment for the folding process, and thus may lower the accuracy in the folding process.

Aspects of non-limiting embodiments of the present disclosure relate to provide a device with a structure that more accurately performs a folding process than a structure that is non-adjustable for the folding process or uneasily prepared for adjustment for the folding process.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a recording-medium processing apparatus including: a mobile body that supports a to-be-pressed portion against which a first end portion of a recording medium that is to undergo a folding process is pressed, the mobile body allowing the to-be-pressed portion to move relative to the mobile body; and a moving mechanism that includes a driving source, and moves the to-be-pressed portion relative to the mobile body.

### BRIEF DESCRIPTION OF THE DRAWINGS

Exemplary embodiments of the present disclosure will be described in detail based on the following figures, wherein:

FIG. 1 is a view of an entire structure of an image forming system;

FIG. 2 is a diagram of a configuration of a controller;

FIG. 3 is a view of a structure of a saddle stitching unit included in a first postprocessor;

FIGS. 4A and 4B are top plan views of an advance member and a folding roller;

FIGS. 5A to 5C are diagrams of actions of components performed by the advance member and the folding roller during a folding process;

FIG. 6 is a perspective view of a mobile body when viewed in a direction of arrow VI in FIG. 3;

FIGS. 7A and 7B are diagrams illustrating the relationship between a motor included in a mobile body, an actuator, and a to-be-pressed portion;

FIG. 8 is a flowchart of an example of a processing flow performed to adjust the position of the to-be-pressed portion;

FIG. 9 is a diagram of another example of a structure of an image forming system;

FIG. 10 is a flowchart of a processing flow performed to adjust the position of the to-be-pressed portion by operating a dedicated receiver;

FIG. 11 is a diagram of another example of a structure of a mobile body;

FIG. 12 is a diagram of an example of an image captured by a scanner reading a test booklet containing a displaced fold;

FIGS. 13A and 13B are diagrams illustrating another example of a displaced fold included in a test booklet;

FIGS. 14A and 14B are diagrams illustrating a folding process performed while a test booklet is generated;

FIG. 15 is another example of a test booklet;

FIGS. 16A and 16B are other examples of a test booklet;

FIG. 17 is another example of a test booklet;

FIG. 18 is a diagram of a single sheet included in a sheet bundle that is to undergo a folding process, which is one of the sheets included in the sheet bundle illustrated in FIG. 5A and located closest to the folding rollers; and

FIGS. 19A and 19B are diagrams of a target sheet while being transported by the folding rollers and after undergoing the folding process.

### DETAILED DESCRIPTION

An exemplary embodiment of the present disclosure is described with reference to the attached drawings below.

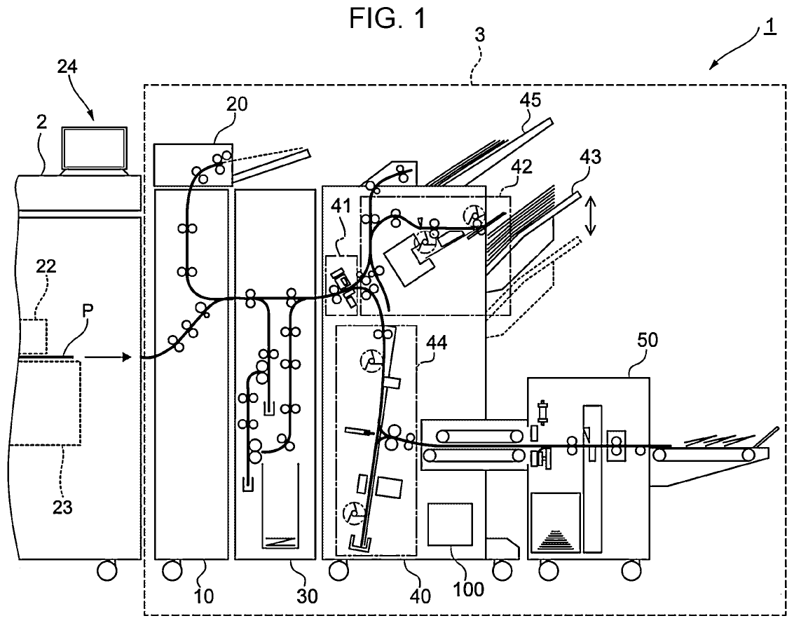

FIG. 1 is a diagram of the entire structure of an image forming system 1. FIG. 1 illustrates the image forming system 1 when the image forming system 1 is viewed from the front.

The image forming system 1 in FIG. 1 includes an image forming apparatus 2 that forms an image on a sheet P serving as an example of a recording medium, and a sheet processor 3 that performs a process on the sheet P on which an image is formed by the image forming apparatus 2.

The image forming apparatus 2 includes an image forming unit 22 for forming an image on the sheet P. The method with which the image forming unit 22 forms images is not limited to a particular one. For example, the image forming unit 22 forms images on the sheet P with an electrophotographic or inkjet method.

The image forming apparatus 2 according to the present exemplary embodiment also includes an inverting mechanism 23 that inverts the sheet P on which an image is formed by the image forming unit 22 and provides the inverted sheet P again to the image forming unit 22. Thus, the image forming apparatus 2 according to the present exemplary embodiment forms images on both surfaces of the sheet P. The inverting mechanism 23 is formed from a known mechanism.

The image forming apparatus 2 according to the present exemplary embodiment also includes an operation receiver 24 at an upper portion of the image forming apparatus 2. The operation receiver 24 receives an operation from a user. The operation receiver 24 receives information input by the user.

Although the operation receiver 24 is formed from, for example, a touch screen, the operation receiver 24 may be formed from a known device such as a physical button.

The sheet processor 3 serving as an example of a recording-medium processing apparatus includes a transporting device 10 that transports the sheet P output from the image forming apparatus 2 downstream, and an inserting-paper feeder 20 that feeds an inserting paper sheet such as cardboard or a window sheet to the sheet P transported by the transporting device 10.

The sheet processor 3 also includes a folding device 30 that performs a folding process on the sheet P transported by the transporting device 10, such as folding the sheet P into a C fold or a Z fold, and a first postprocessor 40 that is disposed downstream from the folding device 30 and performs a binding process or a folding process on a sheet bundle.

The sheet processor 3 also includes a second postprocessor 50 that is disposed downstream from the first postprocessor 40, and performs a process on the sheet bundle that has undergone the binding process or the folding process.

In the present exemplary embodiment, the first postprocessor 40 generates a booklet formed from the sheet bundle that has undergone the binding process or the folding process, and the second postprocessor 50 performs a process on this booklet.

The sheet processor 3 includes a controller 100 that controls each portion of the sheet processor 3.

As illustrated in FIG. 1, the first postprocessor 40 includes a puncher 41 that punches the sheet P, and an edge binding stapler 42 that binds the edge of the sheet bundle.

The first postprocessor 40 also includes a first stacker 43 that receives a sheet bundle with the edge bound. The first postprocessor 40 also includes a second stacker 45 that receives sheets P not processed by the first postprocessor 40 or simply punched sheets P.

The first postprocessor 40 also includes a saddle stitching unit 44 that forms a spread booklet by performing a binding process and a folding process on the sheet bundle.

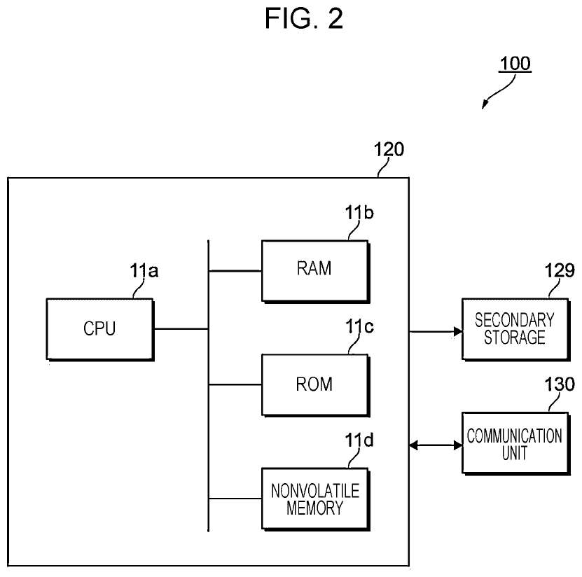

FIG. 2 is a diagram of a structure of the controller 100.

The controller 100 includes a processor 120 that performs digital processing in accordance with a program, a secondary storage 129 that records information such as a program, and a communication unit 130 that transmits and receives information to and from an external device.

The secondary storage 129 is implemented by a known information storage device such as a hard disk drive (HDD), a semiconductor memory, or a magnetic tape.

The processor 120 includes a CPU 11a serving as an example of a processor.

The processor 120 also includes a random-access memory (RAM) 11b used as, for example, a work memory for the CPU 11a, and a read-only memory (ROM) 11c that stores, for example, a program executed by the CPU 11a.

The processor 120 also includes a nonvolatile memory 11d that is rewritable and capable of holding data irrespective of when receiving no power.

The nonvolatile memory 11d is formed from, for example, a flash memory or a static random access memory (SRAM) with battery backup.

In the present exemplary embodiment, the CPU 11a reads the programs stored in the secondary storage 129 or the ROM 11c to perform each process.

The processor 120, the secondary storage 129, and the communication unit 130 are connected to each other through a bus or a signal line.

The programs to be executed by the CPU 11a may be provided to the controller 100 while being stored in a computer-readable recording medium such as a magnetic recording medium (a magnetic tape or a magnetic disc), an optical recording medium (such as an optical disc), a magneto-optical recording medium, or a semiconductor memory. The programs to be executed by the CPU 11a may be provided to the controller 100 through a communication method such as the Internet.

Herein, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

The term “processor” is broad enough to encompass one processor or plural processors in collaboration which are located physically apart from each other but may work cooperatively. The order of operations of the processor is not limited to one described in the embodiments, and may be changed.

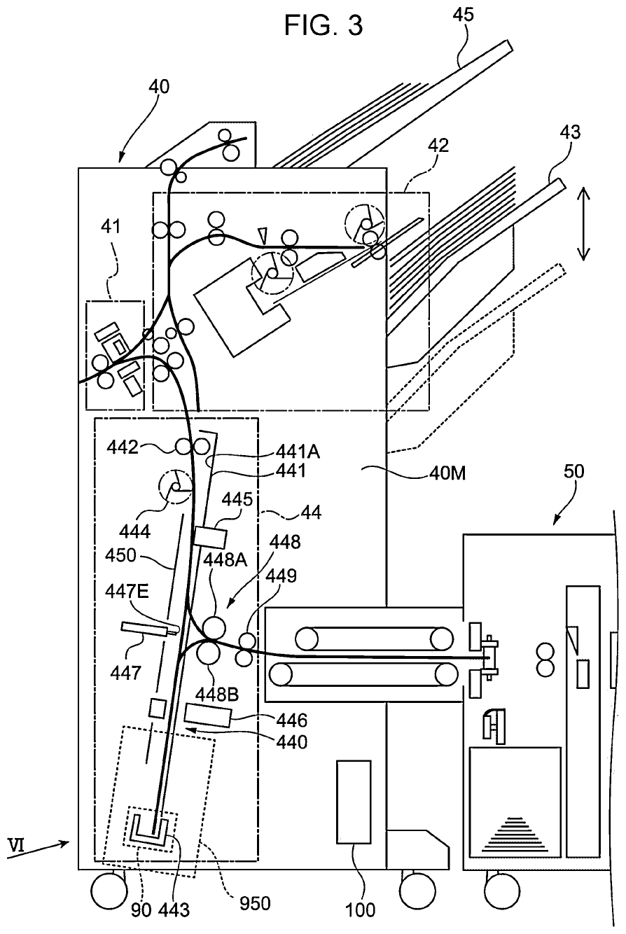

FIG. 3 is a diagram illustrating the structure of the saddle stitching unit 44 included in the first postprocessor 40.

The saddle stitching unit 44 includes a sheet accumulator 440 on which the sheets P are accumulated. The sheet accumulator 440 includes a sheet supporter 441 that supports the sheets P sequentially transported. The sheet supporter 441 is formed from a plate.

The sheet supporter 441 is inclined with respect to the horizontal direction and the vertical direction. The sheet supporter 441 is disposed to be further away from folding rollers 448 (described in detail below) as it extends further downward. The sheet supporter 441 has a support surface 441A that supports the sheets P from below.

A guide 450 that guides the sheets P moving downward is disposed to face the support surface 441A. The guide 450 is disposed along the sheet supporter 441 while leaving a gap between itself and the sheet supporter 441.

The saddle stitching unit 44 also includes pick-up rollers 442 that transport the sheets P downward. The saddle stitching unit 44 also includes to-be-pressed portions 443 against which the lower end portions of the sheets P serving as first end portions are pressed.

In the present exemplary embodiment, the first end portions of the sheets P are pressed against the to-be-pressed portions 443. Thus, the pick-up rollers 442 fix the position of the sheets P in the direction in which the sheets P are transported.

In the present exemplary embodiment, the sheets P transported by the pick-up rollers 442 move downward along the sheet supporter 441. Then, in the present exemplary embodiment, the lower end portions of the sheets P serving as the first end portions abut against the to-be-pressed portions 443.

The saddle stitching unit 44 also includes a mobile body 90 that supports the to-be-pressed portions 443. In the present exemplary embodiment, the to-be-pressed portions 443 are included in the mobile body 90.

The mobile body 90 moves in the direction in which the sheet supporter 441 extends. In other words, the mobile body 90 moves vertically. Thus, in the present exemplary embodiment, the to-be-pressed portions 443 also move in the direction in which the sheet supporter 441 extends.

In the present exemplary embodiment, the to-be-pressed portions 443 are movable relative to the mobile body 90, and thus, the positions of the to-be-pressed portions 443 are adjustable.

In the present exemplary embodiment, a moving mechanism 950 that moves the mobile body 90 along the sheet supporter 441 is disposed.

The moving mechanism 950 is formed from, for example, a rack-and-pinion mechanism. Instead of the rack-and-pinion mechanism, the moving mechanism 950 may be formed from another known mechanism such as a mechanism including a belt that moves circularly.

The saddle stitching unit 44 includes a rotator (described below) that rotates to urge the sheets P accumulated on the sheet supporter 441 toward the to-be-pressed portions 443. This rotator is formed from a rotator body with an elastic piece disposed on its outer circumference.

The saddle stitching unit 44 also includes a pressing member 445 that moves toward the edges of the sheets P to press the edges.

The saddle stitching unit 44 also includes a stapler 446 serving as a binder that performs a binding process on a sheet bundle formed from the sheets P accumulated on the sheet supporter 441.

The present exemplary embodiment is described for the case where the sheet bundle is bound with a sewing needle, but the sheet bundle may be bound by bonding the sheets P together with pressure without using a sewing needle.

The saddle stitching unit 44 also includes an advance member 447 that moves toward the sheet bundle serving as an example of a bundle of recording media from one surface of the sheet bundle and presses the sheet bundle.

In the present exemplary embodiment, the saddle stitching unit 44 also includes folding rollers 448 that serve as a transporter and a presser.

The folding rollers 448 include a pair of rollers that hold therebetween the sheet bundle pressed by the advance member 447 and transported to the folding rollers 448.

In the present exemplary embodiment, a first folding roller 448A located above and a second folding roller 448B located below serve as examples of the pair of rollers. The folding rollers 448 transport the sheet bundle downstream while pressing the sheet bundle.

In the present exemplary embodiment, the saddle stitching unit 44 also includes transport rollers 449 that transport the sheet bundle transported by the folding rollers 448 to the second postprocessor 50.

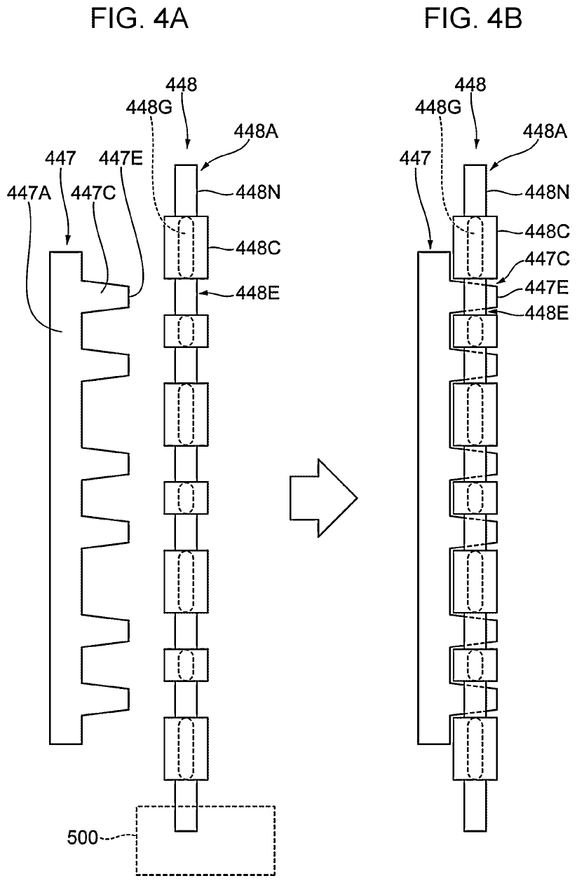

FIGS. 4A and 4B are top plan views of the advance member 447 and one of the folding rollers 448.

As illustrated in FIG. 4A, the first folding roller 448A and the second folding roller 448B (not illustrated in FIGS. 4A and 4B) included in the folding rollers 448 each include a solid cylindrical rotation shaft 448N and hollow cylindrical elastic bodies 448C attached to the outer circumferential surface of the rotation shaft 448N. The elastic bodies 448C are formed from, for example, rubber or soft resin.

The elastic bodies 448C are arranged side by side in the axial direction of the rotation shaft 448N. The elastic bodies 448C adjacent to each other are spaced from each other with a gap 448E.

In the present exemplary embodiment, the folding rollers 448 rotate by receiving the driving force from a driving device 500.

More specifically, in the present exemplary embodiment, the first folding roller 448A rotates by receiving the driving force from the driving device 500. The second folding roller 448B (see FIG. 3) rotates by receiving the driving force from the first folding roller 448A.

The first folding roller 448A and the second folding roller 448B are in contact with each other at contact portions 448G (see FIG. 4A). The second folding roller 448B receives the driving force from the first folding roller 448A at the contact portions 448G.

The driving force may be individually applied to the first folding roller 448A and the second folding roller 448B to rotate the first folding roller 448A and the second folding roller 448B.

The advance member 447 (see FIG. 4A) includes a base 447A that extends in the axial direction of the folding rollers 448, and protrusions 447C that protrude from the base 447A toward the folding rollers 448.

The protrusions 447C are arranged side by side in the axial direction of the folding rollers 448.

In the present exemplary embodiment, when the advance member 447 moves toward the folding rollers 448, as illustrated in FIG. 4B, the protrusions 447C of the advance member 447 enter the gaps 448E in the folding rollers 448.

In the present exemplary embodiment, when the advance member 447 moves forward, distal end portions 447E of the protrusions 447C pass through spaces between the rotation shaft 448N in the first folding roller 448A (see FIG. 4B) and the rotation shaft 448N in the second folding roller 448B (not illustrated in FIG. 4B).

When the advance member 447 moves forward, the distal end portions 447E of the protrusions 447C move to the positions beyond the contact portions 448G where the first folding roller 448A and the second folding roller 448B are in contact with each other.

With reference to FIG. 3, the actions of each component when the folding process or the binding process is performed are described.

When the folding process or the binding process is to be performed, first, feed rollers 442 of the saddle stitching unit 44 transport the sheet P (not illustrated in FIG. 3) from the upstream side to the sheet supporter 441.

When the process is to be performed on multiple sheets P, the feed rollers 442 perform transporting of each sheet P to the sheet supporter 441 multiple times.

Thus, a preset number of sheets P are accumulated on the sheet supporter 441 to generate a sheet bundle on the sheet supporter 441.

In the present exemplary embodiment, the lower end portion of the sheet bundle serving as a first end portion is pressed against the to-be-pressed portions 443 with the gravity exerted on the sheet bundle. More specifically, a sheet bundle is rectangular and has a bottom side. In the present exemplary embodiment, the bottom side is pressed against the to-be-pressed portions 443.

When the sheet bundle is formed from a single sheet P, the single sheet P is received on the sheet supporter 441. Herein, “a sheet bundle” includes a sheet bundle formed from a single sheet P.

When the sheets P are accumulated on the sheet supporter 441, the to-be-pressed portions 443 that support the sheets P from below are stopped to allow, for example, the center portions of the sheets P to be located at a stapling position where the stapler 446 performs stapling. At this time, the rotator (not illustrated in FIG. 3) rotates to urge the accumulated sheets P against the to-be-pressed portions 443.

When the sheets P are accumulated on the sheet supporter 441, the pressing member 445 presses the edge of each sheet P every time the sheet P is transported onto the sheet supporter 441.

After a predetermined number of sheets P are accumulated on the sheet supporter 441 to generate a sheet bundle, the stapler 446 performs a binding process on the sheet bundle at, for example, the center portion.

The stapler 446 does not perform the binding process when the folding process is simply performed without the binding process.

Subsequently, the mobile body 90 moves upward, and accompanied with the upward movement, the to-be-pressed portions 443 that support the sheet bundle move upward.

Thus, a to-be-folded portion that is to undergo the folding process is located to face the distal end portions 447E of the advance member 447. More specifically, for example, the center portion of the sheet bundle is located to face the distal end portions 447E of the advance member 447.

Thus far, the above described case is a case where the to-be-pressed portions 443 are disposed to allow the center portion of the sheets P to be located at the stapling position where the stapler 446 performs stapling when the sheets P are accumulated on the sheet supporter 441. However, the to-be-pressed portions 443 may be located at different positions.

When the binding process using the stapler 446 is not performed, the to-be-pressed portions 443 may be located to allow the center portion of the sheets P to be located to face the distal end portions 447E of the advance member 447.

More specifically, the mobile body 90 may be located higher than the position illustrated in FIG. 3, and the to-be-pressed portions 443 may be located to allow the center portion of the sheets P to be located to face the distal end portions 447E of the advance member 447.

After the center portion of the sheet bundle moves to the position to face the distal end portions 447E of the advance member 447, the advance member 447 moves toward the sheet bundle from the first side of the sheet bundle to press the sheet bundle.

Thus, the sheet bundle passes through an opening (not illustrated in FIG. 3) formed in the sheet supporter 441 to move toward the folding rollers 448 at the back of the sheet supporter 441.

Then, the sheet bundle is pressed from both sides by the folding rollers 448. In addition, the folding rollers 448 start transporting the sheet bundle.

The advance member 447 according to the present exemplary embodiment moves to the position where the folding rollers 448 are installed. More specifically, in the present exemplary embodiment, as illustrated in FIG. 4B, the distal end portions 447E of the advance member 447 move downstream beyond the contact portions 448G in the folding rollers 448.

Thus, a sheet bundle that has undergone the binding process performed by the stapler 446 and the folding process performed by the advance member 447 and the folding rollers 448 is generated.

Alternatively, a sheet bundle that has simply undergone the folding process performed by the advance member 447 and the folding rollers 448 without the binding process performed by the stapler 446 is generated.

Thereafter, the sheet bundle is transported to the second postprocessor 50 by the transport rollers 449.

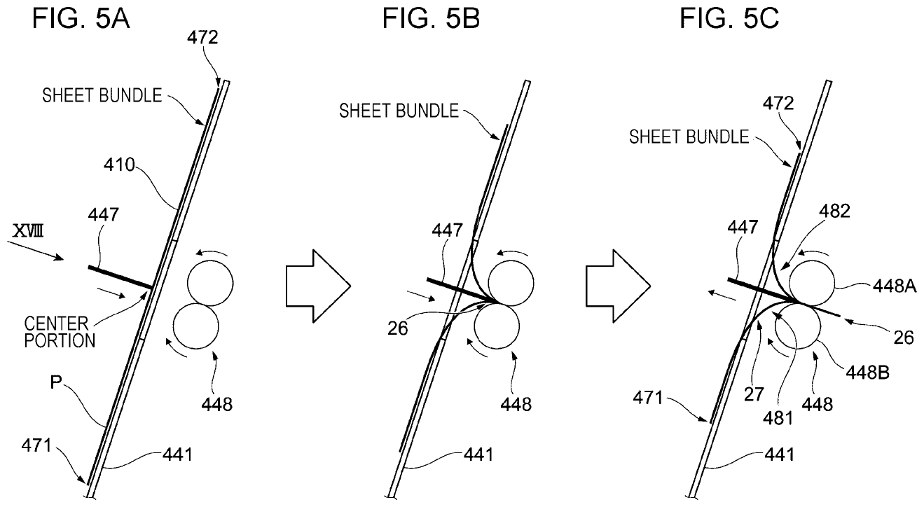

FIGS. 5A to 5C illustrate the actions of components performed when the advance member 447 and the folding rollers 448 perform the folding process.

As illustrated in FIG. 5A, first, when the folding process is performed, the advance member 447 moves toward the sheet bundle from a first surface 410 of the sheet bundle.

At this time, in the present exemplary embodiment, a first end portion 471 of the sheet bundle is located at the bottom and a second end portion 472 of the sheet bundle is located at the top. In other words, the bottom side of the sheet bundle is located at the bottom, and the top side of the sheet bundle is located at the top.

At this time, with the gravity exerted on the sheet bundle, the first end portion 471 of the sheet bundle is pressed against the to-be-pressed portions 443 (not illustrated in FIGS. 5A, 5B, and 5C and see FIG. 3). In other words, the bottom side of the sheet bundle is pressed against the to-be-pressed portions 443.

Thereafter, as illustrated in FIG. 5B, the center portion of the sheet bundle arrives at the folding rollers 448. In other words, the portion of the sheet bundle that is pressed by the advance member 447 arrives at the folding rollers 448.

The center portion of the sheet bundle is a pressed portion 26, or a portion that is pressed by the advance member 447. In the present exemplary embodiment, the pressed portion 26 serves as the leading end while moving, and the pressed portion 26 arrives at the folding rollers 448.

As illustrated in FIG. 5C, the folding rollers 448 press the sheet bundle.

In the present exemplary embodiment, the folding rollers 448 comes into contact with a surface 27 (see FIG. 5C) of the sheet bundle that is caused to be located on the outer side as a result of the folding process to press the sheet bundle.

More specifically, in the present exemplary embodiment, the second folding roller 448B comes into contact with the surface 27 that is caused to be located on the outer side at a portion located between the pressed portion 26 and the first end portion 471. The first folding roller 448A comes into contact with the surface 27 that is caused to be located on the outer side at a portion located between the pressed portion 26 and the second end portion 472.

In the present exemplary embodiment, when the folding rollers 448 come into contact with the surface 27 of the sheet bundle that is caused to be located on the outer side, the sheet bundle starts being transported downstream in a direction in which the sheet bundle moves.

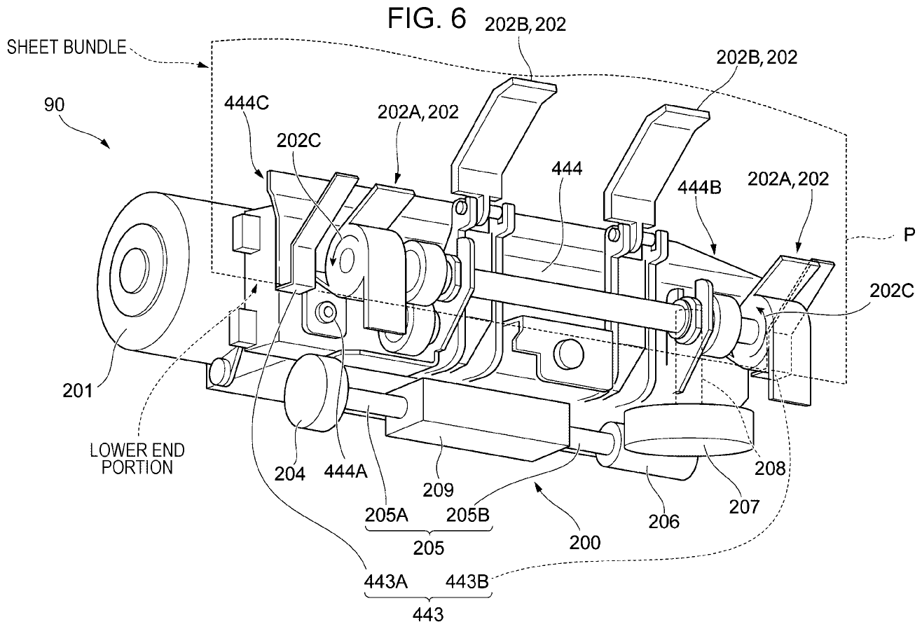

FIG. 6 is a perspective view of the mobile body 90 when viewed in a direction of arrow VI in FIG. 3.

In the present exemplary embodiment, the to-be-pressed portions 443 include a first edge-side portion 443A against which the bottom side of the rectangular sheet bundle at its first edge portion in the longitudinal direction is pressed, and a second edge-side portion 443B against which the bottom side of the sheet bundle at its second edge portion in the longitudinal direction is pressed.

The bottom side of the sheet bundle is also regarded as the first end portion of the sheet bundle. Thus, in the present exemplary embodiment, the to-be-pressed portions 443 include the first edge-side portion 443A against which the first end portion at its first edge side in a longitudinal direction is pressed, and the second edge-side portion 443B against which the first end portion at its second edge side in the longitudinal direction is pressed.

The first edge-side portion 443A and the second edge-side portion 443B in the to-be-pressed portions 443 are supported by a common supporter 444 that extends in the lateral direction in the drawing. The supporter 444 is rotatable about a rotation shaft 444A located at the left in the drawing.

In other words, the supporter 444 is rotatable about the rotation shaft 444A located closer to the first edge-side portion 443A in the to-be-pressed portions 443.

A moving mechanism 200 that moves the to-be-pressed portions 443 relative to the mobile body 90 according to the present exemplary embodiment is disposed at the mobile body 90.

The moving mechanism 200 includes a motor 201 serving as an example of a driving source. The moving mechanism 200 moves the to-be-pressed portions 443 using the driving force produced by the motor 201.

In the present exemplary embodiment, the moving mechanism 200 including the motor 201 is disposed at the mobile body 90, and moves together with the mobile body 90.

In the present exemplary embodiment, the mobile body 90 also includes actuators 202 that operate by receiving the driving force from the motor 201.

The actuators 202 rotate or move by receiving the driving force from the motor 201. The actuators 202 come into contact with the sheets P that constitute the sheet bundle.

More specifically, the moving mechanism 200 according to the present exemplary embodiment include two types of actuators 202, that is, two rotators 202A serving as one example of the actuators 202 and two pressing members 202B serving as another example of the actuators 202.

The rotators 202A rotate in the direction of arrows 202C to urge the sheets P to be subjected to the folding process toward the to-be-pressed portions 443.

In the present exemplary embodiment, elastic pieces disposed on the outer circumferential surfaces of the rotators 202A come into contact with the sheets P, and the sheets P are urged toward the to-be-pressed portions 443.

The pressing members 202B move toward an opposing member (not illustrated) located at a position facing the pressing members 202B to urge the sheet bundle located between the pressing members 202B and the opposing member toward the opposing member.

In the present exemplary embodiment, as described above, the pick-up rollers 442 (see FIG. 3) transport the sheet P, a sheet bundle is generated on the to-be-pressed portions 443, and the mobile body 90 moves upward.

While the mobile body 90 moves upward, the pressing members 202B (see FIG. 6) move toward the opposing member, and the generated sheet bundle is held between the pressing members 202B and the opposing member. Thus, misregistration of the sheet bundle is reduced.

In the present exemplary embodiment, the motor 201 serving as a common driving source provides the driving force to the rotators 202A, the pressing members 202B, and the to-be-pressed portions 443.

The moving mechanism 200 includes a receiving gear 204 that receives the driving force from the motor 201, a transmission gear (not illustrated) that transmits the driving force from the motor 201 to the receiving gear 204, and a rotation shaft 205 located coaxial with the receiving gear 204.

The moving mechanism 200 also includes a worm 206 that rotates by receiving the driving force from the rotation shaft 205, a worm wheel 207 that rotates by receiving the driving force from the worm 206, and a coaxial shaft 208 located coaxial with the worm wheel 207.

The moving mechanism 200 also includes a clutch 209 serving as an example of a disconnector that disconnects the transmission of the driving force from the motor 201 serving as a driving source to the to-be-pressed portions 443.

The moving mechanism 200 according to the exemplary embodiment includes the clutch 209 that disconnects and connects the driving force transmitted from the motor 201 to the to-be-pressed portions 443 through a transmission path of the driving force.

The clutch 209 according to the present exemplary embodiment is formed from an electromagnetic clutch, and operates in accordance with an instruction from the CPU 11a (see FIG. 2).

The clutch 209 is disposed on the rotation shaft 205 to transmit and interrupt the driving force transmitted to the to-be-pressed portions 443 through the rotation shaft 205.

The rotation shaft 205 includes a first rotation shaft 205A and a second rotation shaft 205B located coaxial with the first rotation shaft 205A. In the present exemplary embodiment, the clutch 209 is disposed between the first rotation shaft 205A and the second rotation shaft 205B.

The clutch 209 connects the first rotation shaft 205A and the second rotation shaft 205B to each other, and disconnects the first rotation shaft 205A and the second rotation shaft 205B from each other.

The moving mechanism 200 moves the second edge-side portion 443B relative to the first edge-side portion 443A in the to-be-pressed portions 443 to change the positional relationship between the first edge-side portion 443A and the second edge-side portion 443B.

More specifically, the moving mechanism 200 rotates the supporter 444 about the rotation shaft 444A using the driving force from the motor 201 to vertically move the second edge-side portion 443B in the to-be-pressed portions 443.

Thus, the second edge-side portion 443B moves relative to the first edge-side portion 443A, and the positional relationship between the first edge-side portion 443A and the second edge-side portion 443B is changed.

More specifically, in the present exemplary embodiment, when the motor 201 included in the moving mechanism 200 drives, the driving force produced by the motor 201 is transmitted to the supporter 444 via the transmission gear (not illustrated), the receiving gear 204, the first rotation shaft 205A, the clutch 209, the second rotation shaft 205B, the worm 206, the worm wheel 207, and the coaxial shaft 208.

Thus, a second edge portion 444B of the supporter 444 moves vertically, and accompanied with the vertical movement, the second edge-side portion 443B moves relative to the first edge-side portion 443A in the to-be-pressed portions 443. Thus, the positional relationship between the first edge-side portion 443A and the second edge-side portion 443B is changed.

The coaxial shaft 208 has an external screw on the outer circumferential portion, and the supporter 444 has a through-hole (not illustrated) that allows the coaxial shaft 208 to pass therethrough. The supporter 444 also has, on the internal circumferential surface of the through-hole, an internal screw engageable with the external screw on the outer circumferential portion of the coaxial shaft 208.

In the present exemplary embodiment, accompanied with rotation of the coaxial shaft 208, the second edge portion 444B of the supporter 444 moves in the axial direction of the coaxial shaft 208. Thus, the second edge-side portion 443B moves relative to the first edge-side portion 443A in the to-be-pressed portions 443.

The moving mechanism 200 according to the present exemplary embodiment moves the to-be-pressed portions 443 to change the positional relationship between the first edge-side portion 443A and the second edge-side portion 443B in the to-be-pressed portions 443 in the direction crossing the longitudinal direction of the bottom side of the sheet bundle.

More specifically, the moving mechanism 200 changes the relationship between the position of the first edge-side portion 443A and the position of the second edge-side portion 443B in the direction perpendicular to the longitudinal direction of the bottom side of the sheet bundle.

The present exemplary embodiment has been described for the case where the second edge-side portion 443B in the to-be-pressed portions 443 moves as an example. Instead, the first edge-side portion 443A may move or both of the first edge-side portion 443A and the second edge-side portion 443B may move.

When both of the first edge-side portion 443A and the second edge-side portion 443B move, the first edge-side portion 443A and the second edge-side portion 443B may move individually.

Alternatively, a driving source different from the driving source that moves the second edge-side portion 443B in the to-be-pressed portions 443 may be provided to move the first edge-side portion 443A in the to-be-pressed portions 443.

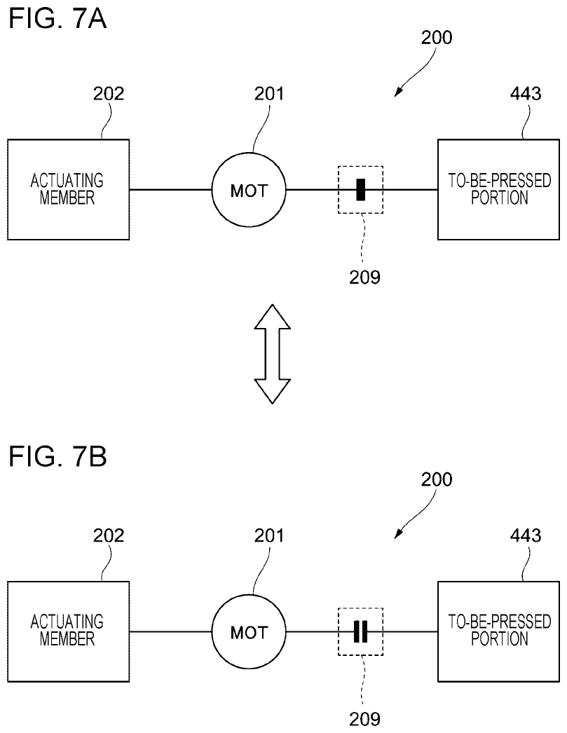

FIGS. 7A and 7B are diagrams illustrating the relationship between one actuator 202, one to-be-pressed portion 443, and the motor 201 installed in the mobile body 90.

As described above, the present exemplary embodiment includes the motor 201 serving as a common driving source, as illustrated in FIG. 7A, and the actuator 202 and the to-be-pressed portion 443 are connected to the motor 201.

The clutch 209 serving as a disconnector is disposed between the motor 201 and the to-be-pressed portion 443. In the state illustrated in FIG. 7A, the clutch 209 connects the motor 201 and the to-be-pressed portion 443 to each other.

In this state, the driving force from the motor 201 is transmitted to both of the actuator 202 and the to-be-pressed portion 443. In this case, the actuator 202 operates and the to-be-pressed portion 443 moves. In the movement of the to-be-pressed portion 443, as described above, the second edge-side portion 443B in the to-be-pressed portions 443 moves.

FIG. 7B illustrates a state where the clutch 209 operates and the motor 201 and the to-be-pressed portion 443 are disconnected from each other. In other words, FIG. 7B illustrates a state where the transmission path for the driving force connecting the motor 201 and the to-be-pressed portion 443 to each other is disconnected.

In this case, the motor 201 simply operates the actuator 202.

In the present exemplary embodiment, the moving mechanism 200 is in the state illustrated in FIG. 7A when the position of the to-be-pressed portion 443 is to be adjusted.

In the present exemplary embodiment, the moving mechanism 200 is in the state illustrated in FIG. 7B when the position of the to-be-pressed portion 443 is not to be adjusted. In other words, the moving mechanism 200 is in the state illustrated in FIG. 7B when a normal folding process is to be performed.

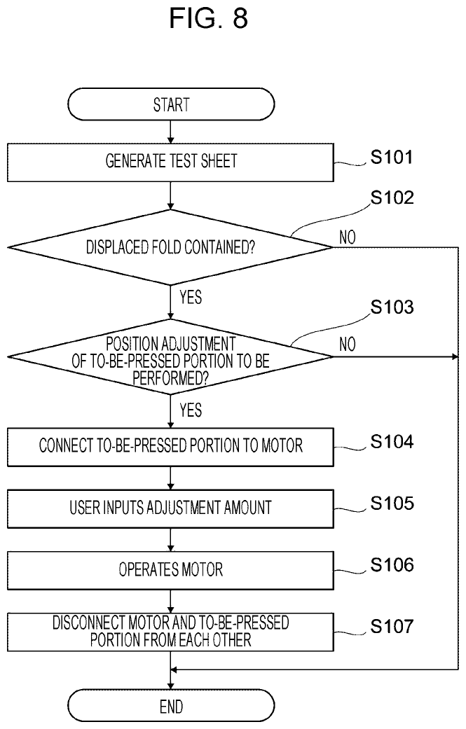

FIG. 8 is a flowchart illustrating an example of a processing flow performed when the position adjustment of the to-be-pressed portions 443 is to be performed.

When the position adjustment of the to-be-pressed portions 443 is to be performed, first, a rectangular test sheet P (hereafter referred to as “a test sheet PS”) is fed to the saddle stitching unit 44. This test sheet PS is one sheet P accommodated in the image forming apparatus 2 (see FIG. 1) instead of a special sheet P.

When the test sheet PS is fed to the saddle stitching unit 44, the folding process is performed on the test sheet PS, and after the folding process is performed, a booklet formed from this test sheet PS (hereafter, referred to as “a test booklet”) is generated (step S101).

In the position adjustment of the to-be-pressed portions 443, only the advance member 447 performs the folding process on the test sheet PS without the stapler 446 (see FIG. 3) performing the binding process.

After the generation of the test booklet, a user visually checks the generated test booklet to determine whether the test booklet contains a displaced fold (step S102).

In the present exemplary embodiment, when the to-be-pressed portions 443 is inclined, this inclination forms a displaced fold in a test booklet. In other words, when the position of the first edge-side portion 443A in the to-be-pressed portions 443 and the position of the second edge-side portion 443B in the to-be-pressed portions 443 differ from each other in the height direction, the test booklet contains a displaced fold.

When the user determines that the test booklet contains a displaced fold, the user determines whether position adjustment of the to-be-pressed portions 443 is to be performed (step S103).

When the user determines to perform the position adjustment of the to-be-pressed portions 443 in step S103, the user performs an operation on the operation receiver 24 (see FIG. 1) to input information indicating that the position adjustment of the to-be-pressed portions 443 is to be performed.

Thus, in the present exemplary embodiment, the CPU 11a outputs a control signal to operate the clutch 209 (see FIG. 6) to connect the to-be-pressed portions 443 to the motor 201 (step S104).

When the user does not determine that the test booklet contains a displaced fold in step S102, or when the user does not determine to perform the position adjustment of the to-be-pressed portions 443 in step S103, the processing is finished.

Subsequently, the user operates on the operation receiver 24 to input an adjustment amount to adjust the position of the to-be-pressed portions 443 (step S105). More specifically, the user inputs an amount of movement of the to-be-pressed portions 443.

Accordingly, the CPU 11a operates the motor 201 serving as a driving source (step S106). Thus, the to-be-pressed portions 443 move to perform the position adjustment of the to-be-pressed portions 443. More specifically, in the present exemplary embodiment, the second edge-side portion 443B in the to-be-pressed portion 443 moves vertically to perform the position adjustment of the to-be-pressed portions 443.

Thereafter, the CPU 11a outputs a control signal to the clutch 209 to disconnect the motor 201 and the to-be-pressed portions 443 from each other (step S107).

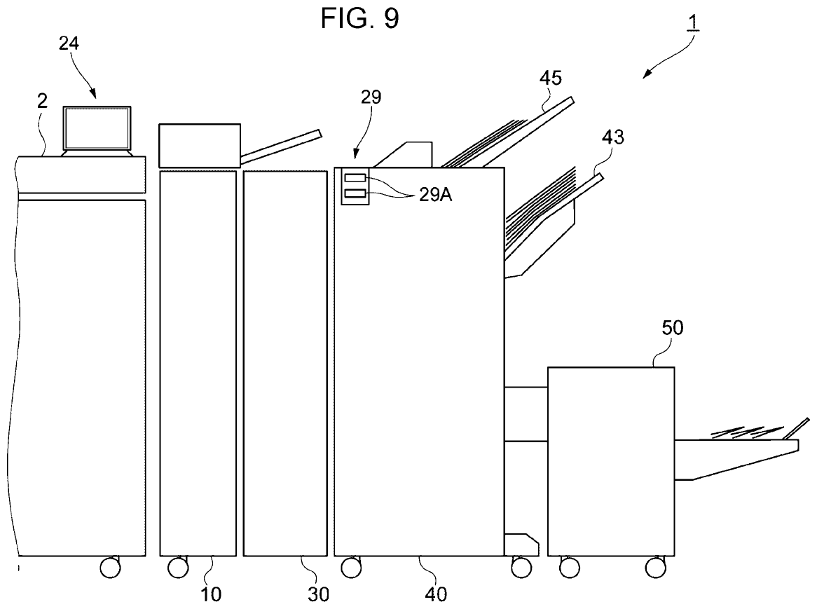

FIG. 9 is a diagram of another example of the structure of the image forming system 1. FIG. 9 illustrates the external appearance of the image forming system 1.

In the above description, when the user is to perform the position adjustment of the to-be-pressed portions 443, the user performs the operation on the operation receiver 24.

In contrast, in this structure example, the first postprocessor 40 includes an operation receiver 29 dedicated to the position adjustment of the to-be-pressed portions 443 (hereafter, referred to as “a dedicated receiver 29”).

In this structure example, when the user performs the position adjustment of the to-be-pressed portions 443, the user performs the operation on the dedicated receiver 29. The dedicated receiver 29 includes operation buttons 29A to be touched by the user.

As in this structure example illustrated in FIG. 9, the first postprocessor 40 that includes the dedicated receiver 29 receiving the operation of the user allows the user to perform the position adjustment of the to-be-pressed portions 443 without being bothered moving to a position of the operation receiver 24 at the upper portion of the image forming apparatus 2.

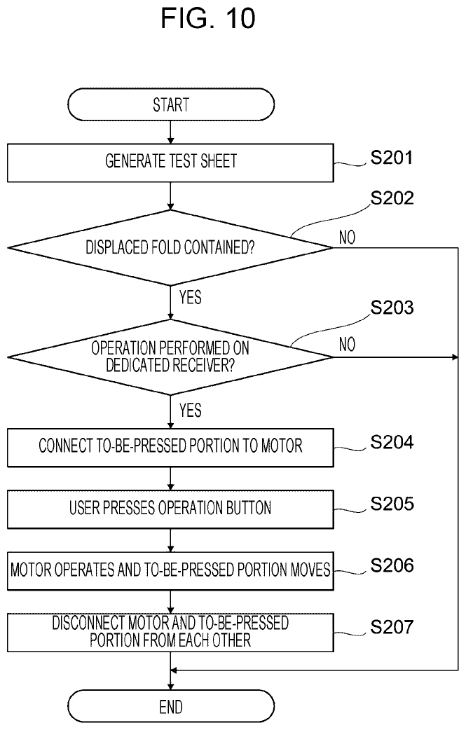

FIG. 10 is a flowchart indicating the processing flow performed when the dedicated receiver 29 is operated to perform the position adjustment of the to-be-pressed portions 443.

As in the above example, also in the processing illustrated in FIG. 10, the test sheet PS is fed to the saddle stitching unit 44 to undergo the folding process. Thus, after the test sheet PS undergoes the folding process, this test sheet PS is formed into a test booklet (step S201).

The user then visually checks the generated test booklet to determine whether the test booklet contains a displaced fold (step S202). As in the above example, when the to-be-pressed portions 443 are inclined, this inclination forms a displaced fold in a test booklet.

Thereafter, when the user determines that the test booklet contains a displaced fold, the user determines whether to perform an operation on the dedicated receiver 29 (step S203).

When the user determines to perform an operation on the dedicated receiver 29, the user performs an operation on the dedicated receiver 29.

When the user performs the operation on the dedicated receiver 29, as in the above example, the CPU 11a outputs a control signal to the clutch 209 to connect the to-be-pressed portions 443 to the motor 201 (step S204).

When the user does not determine that the test booklet contains a displaced fold in step S202, or when the user does not determine to perform an operation on the dedicated receiver 29 in step S203, the processing is finished.

Subsequently, the user presses one of the operation buttons 29A included in the dedicated receiver 29 (step S205). At this time, the user presses the operation button 29A for a time length corresponding to the quantity of displacement of the fold.

When the user presses the operation button 29A, the motor 201 operates and the to-be-pressed portions 443 move (step S206). In the present exemplary embodiment, while the operation button 29A is being pressed by the user, the motor 201 operates and the to-be-pressed portions 443 move.

Thereafter, the user performs an operation on a predetermined portion of the dedicated receiver 29. Thus, the clutch 209 operates again to disconnect the motor 201 and the to-be-pressed portions 443 from each other (step S207).

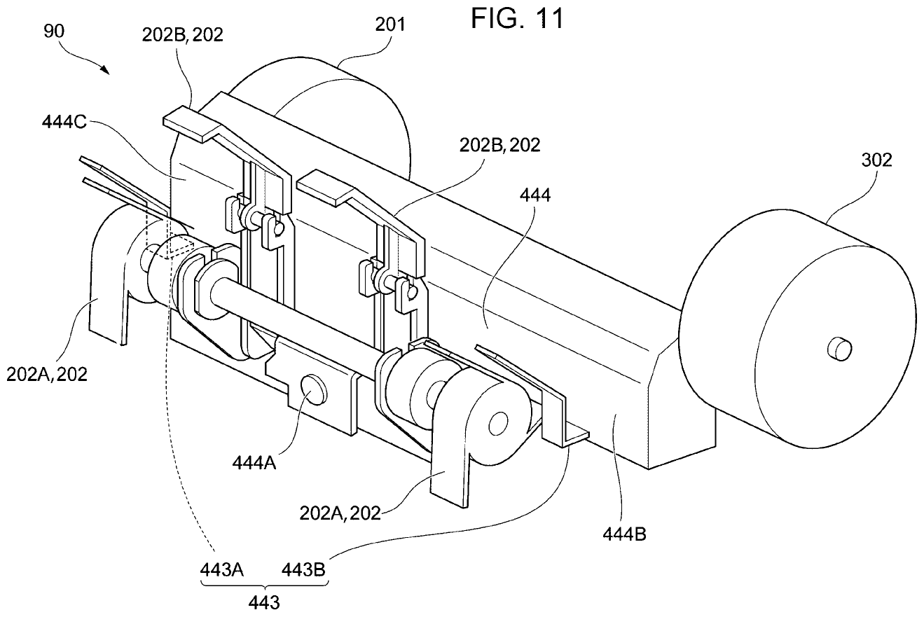

FIG. 11 is a diagram of another example of the structure of the mobile body 90.

The case described above is a case where the single motor 201 serving as a common driving source is used to move the to-be-pressed portions 443 and to operate the actuators 202.

The structure example illustrated in FIG. 11 includes, separate from the first motor 201 or the motor 201 connected to the actuators 202, a second motor 302 serving as a dedicated driving source to move the to-be-pressed portions 443.

In the present exemplary embodiment, the driving force from the dedicated second motor 302 is transmitted to the second edge portion 444B of the supporter 444 by a transmission mechanism not illustrated. Thus, the second edge portion 444B of the supporter 444 moves vertically, and accompanied with this vertical movement, the second edge-side portion 443B in the to-be-pressed portions 443 moves vertically.

The structure example illustrated in FIG. 11 includes the rotation shaft 444A between a first edge portion 444C and the second edge portion 444B in the supporter 444. When the second edge portion 444B of the supporter 444 moves vertically, the first edge portion 444C of the supporter 444 also moves vertically.

In this structure example, when the second edge-side portion 443B in the to-be-pressed portions 443 moves upward, the first edge-side portion 443A in the to-be-pressed portions 443 moves downward, and when the second edge-side portion 443B in the to-be-pressed portions 443 moves downward, the first edge-side portion 443A in the to-be-pressed portions 443 moves upward.

In this structure example, the first motor 201 operates the actuators 202, and the second motor 302 moves the to-be-pressed portions 443. This structure example does not include the clutch 209.

Setting of Distance by which to-be-Pressed Portions 443 Move

The case described above is the case where the user determines, by himself/herself, the distance by which the to-be-pressed portions 443 move. Instead, the CPU 11a serving as an example of a processor may set the distance by which the to-be-pressed portions 443 move.

When the CPU 11a sets the distance by which the to-be-pressed portions 443 move, the CPU 11a sets the distance based on the quantity of displacement of the fold formed in the generated test booklet.

In the present exemplary embodiment, when the CPU 11a sets the distance by which the to-be-pressed portions 443 move, the CPU 11a operates the moving mechanism 200 to move the to-be-pressed portions 443 by the set distance of movement.

In the present exemplary embodiment, the bottom side is pressed against the to-be-pressed portions 443 to have its position fixed by the to-be-pressed portions 443, and then the folding process is performed on the test sheet PS.

The CPU 11a sets the distance of movement based on the quantity of displacement of the fold formed in the test booklet formed from the test sheet PS having its position fixed and then undergoing the folding process.

The CPU 11a specifies the quantity of displacement of the fold based on, for example, the quantity of displacement of the fold formed in the test booklet input by the user through the operation receiver 24.

In addition, the CPU 11a specifies the quantity of displacement of the fold based on, for example, a captured image obtained by capturing the image of the test booklet.

Specifying the quantity of displacement of the fold based on the captured image reduces the burden on the user, and improves the accuracy in specifying the quantity of displacement of the fold compared to the case where the user specifies the quantity of displacement of the fold.

When the user inputs the quantity of displacement through the operation receiver 24, the user is bothered manually measuring the quantity of displacement and manually inputting information as to the quantity of displacement.

In contrast, when the quantity of displacement of the fold is specified based on the captured image, these operations to be performed by the user are omitted.

After specifying the quantity of displacement of the fold, the CPU 11a sets the distance by which the to-be-pressed portions 443 move based on the specified quantity of displacement of the fold.

To specify the quantity of displacement of the fold based on the captured image, for example, first, the user places the test booklet on a scanner (not illustrated), and the scanner reads the test booklet.

More specifically, the scanner reads a test booklet placed on its document table while pressing the test booklet with an openable open-close member in the scanner.

Subsequently, the CPU 11a analyses the captured image obtained by the scanner when it reads the test booklet, and specifies the quantity of displacement of the fold in the test booklet.

Based on the specified quantity of displacement, the CPU 11a sets the distance by which the to-be-pressed portions 443 move.

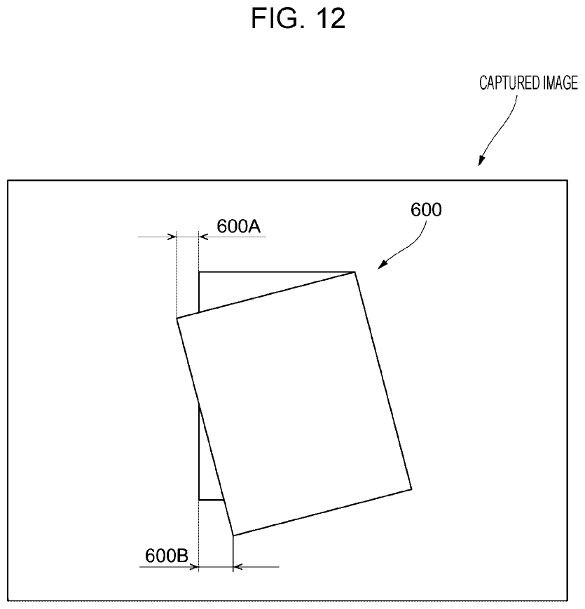

FIG. 12 illustrates an example of a captured image obtained by reading the test booklet containing a displaced fold with a scanner.

When a test booklet 600 contains a displaced fold, the test booklet 600 is in the state illustrated in FIG. 12.

When the CPU 11a specifies the quantity of displacement of the fold in the test booklet 600, for example, the CPU 11a obtains the dimensions of portions 600A and 600B, and specifies these dimensions as the quantity of displacement of the fold.

Based on the specified quantity of displacement, the CPU 11a operates the moving mechanism 200 to move the to-be-pressed portions 443.

In the above description, an aspect where the second edge-side portion 443B in the to-be-pressed portions 443 is vertically moved is described as a basic aspect of moving the to-be-pressed portions 443.

The aspect of moving the to-be-pressed portions 443 is not limited to this. The to-be-pressed portions 443 may be moved by moving, for example, both of the first edge-side portion 443A and the second edge-side portion 443B upward by the same distance.

Instead, for example, the to-be-pressed portions 443 may be moved by, for example, moving both of the first edge-side portion 443A and the second edge-side portion 443B downward by the same distance.

Also in this case, the quantity of displacement of the fold formed in the sheet bundle is reduced.

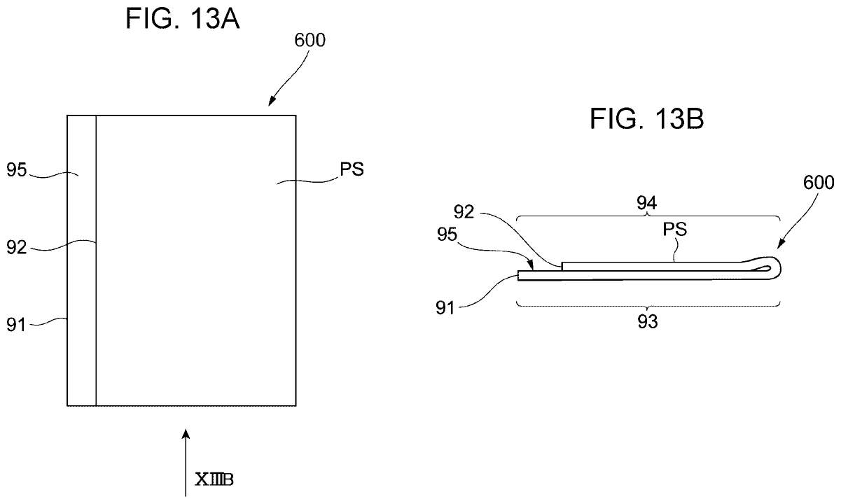

FIGS. 13A and 13B are diagrams of another example of a displaced fold formed in the test booklet 600. FIG. 13A is a front view of the test booklet 600, and FIG. 13B is a side view of the test booklet 600 when viewed in the direction of arrow XIIIB in FIG. 13A.

When the test booklet 600 contains a displaced fold, as illustrated in FIG. 13A, the displaced fold may be formed while a first end portion 91 and a second end portion 92 in the test sheet PS forming the test booklet 600 are parallel to each other.

In other words, a displaced fold may be formed while a first edge and a second edge of the test sheet PS are parallel to each other.

To perform position adjustment of the to-be-pressed portions 443 in this state, as described above, both the first edge-side portion 443A and the second edge-side portion 443B in the to-be-pressed portions 443 are moved upward or downward by the same distance. Thus, the quantity of displacement of the fold formed in the sheet bundle is reduced.

As illustrated in FIG. 13B, the test booklet 600 obtained by performing the folding process on the test sheet PS includes a first surface 93 and a second surface 94.

When the test booklet 600 is to be read by the scanner, the test booklet 600 is placed on the document table in the scanner while having one of the first surface 93 and the second surface 94 of the test booklet 600 facing the document table.

When the test booklet 600 containing a displaced fold is viewed from the first surface 93 or the second surface 94, a portion that is supposed to be located inward in the test booklet 600 is exposed to form an exposed portion 95 as illustrated in FIG. 13A.

When the test booklet 600 is to be read by the scanner, the test booklet 600 is placed on the document table in the scanner while having one of the first surface 93 and the second surface 94 of the test booklet 600 that makes the exposed portion 95 viewable facing the document table.

Then, the scanner reads the test booklet 600 from the surface that makes the exposed portion 95 viewable.

When the test booklet 600 containing a displaced fold is placed on the scanner and the quantity of displacement of the fold is small, the exposed portion 95 is unnoticeable.

In this case, the user may place the test booklet 600 on the scanner while having a surface opposite to the surface that makes the exposed portion 95 viewable facing the scanner. In this case, the scanner fails to specify the quantity of displacement of the fold.

When specifying the quantity of displacement of the fold in the test booklet 600, the CPU 11a specifies two end portions, that is, the first end portion 91 and the second end portion 92 of the test sheet PS forming the test booklet 600 from among, for example, the captured image obtained by the scanner when it reads the test booklet 600.

The CPU 11a then specifies the quantity of displacement based on the positions of the specified two end portions.

In this case, when the test booklet 600 is placed on the scanner while having the opposite surface facing the scanner, the scanner fails to specify the two end portions, and thus fails to specify the quantity of displacement of the fold.

Although the details are described below, the quantity of displacement of the fold may be specified using an image formed on at least one of the two surfaces of the test sheet PS forming the test booklet 600.

In this case, when the quantity of displacement of the fold is small, this image is hidden, and the scanner fails to specify the quantity of displacement of the fold. In this case, the conditions for adjustment of the folding process are unprepared, and thus, the adjustment of the folding process is failed.

Thus, as described below, to generate the test booklet 600, the position of a to-be-folded portion of the test sheet PS that is subjected to the folding process is preferably intentionally displaced by a large quantity of displacement.

In the present exemplary embodiment, as illustrated in FIGS. 5A to 5C, the saddle stitching unit 44 that normally functions as a folding member performs a folding process on a sheet bundle including the first end portion 471, the second end portion 472, and a center portion at a portion between the first end portion 471 and the second end portion 472. More specifically, the saddle stitching unit 44 performs the folding process on the center portion of the sheet bundle.

Thus, the saddle stitching unit 44 generates a sheet bundle including the pressed portion 26 (see FIG. 5C) serving as a to-be-folded portion, a first-end-side portion 481 disposed between the pressed portion 26 and the first end portion 471, and a second-end-side portion 482 disposed between the pressed portion 26 and the second end portion 472.

When the folding process is performed on the center portion of the sheet bundle, the dimension between the pressed portion 26 serving as the to-be-folded portion and the first end portion 471 and the dimension between the pressed portion 26 and the second end portion 472 are equal to each other.

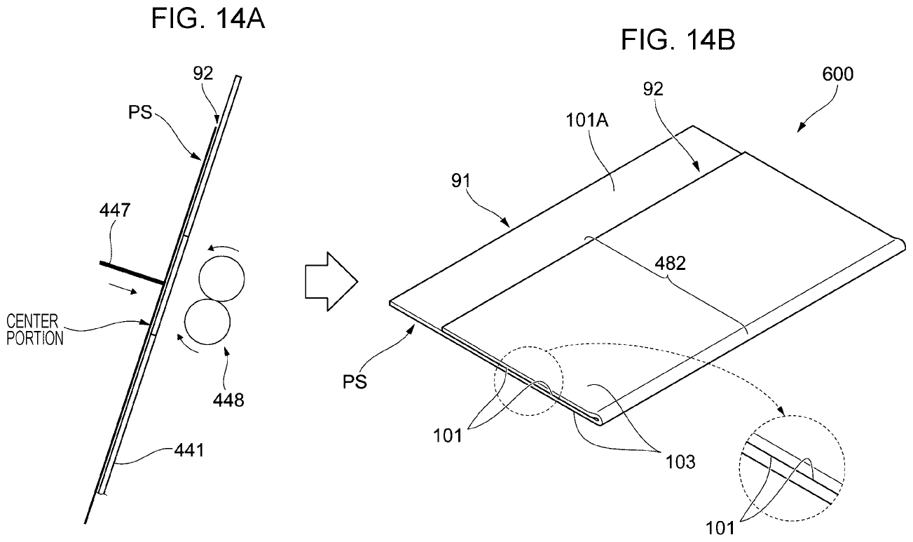

FIGS. 14A and 14B are diagrams illustrating the folding process performed to generate the test booklet 600.

As illustrated in FIG. 14A, to generate the test booklet 600, the CPU 11a performs the folding process on the test sheet PS at, for example, a portion closer to the second end portion 92 with respect to the center portion.

More specifically, in this case, the CPU 11a performs the folding process on the test sheet PS at a portion closer to the second end portion 92 with respect to the center portion while changing the stop position of the mobile body 90 (see FIG. 3) to be lower than the usual stop position.

As this time, as illustrated in FIG. 14B, a specific portion 101A of a first surface 101 that is caused to be located on the inner side by the folding process is left uncovered with the second-end-side portion 482.

The test sheet PS has the first surface 101 and a second surface 103. In the present exemplary embodiment, the specific portion 101A of the first surface 101 is left uncovered with the second-end-side portion 482.

More specifically, in this example, the end portion of the first surface 101 of the test sheet PS corresponds to the specific portion 101A, and this end portion of the first surface 101 is exposed without being covered with the second-end-side portion 482.

In this case, the existence of the displaced fold is further clarified. In this case, the user more easily identifies the side having the displaced fold. Thus, the user is less likely to place the test booklet 600 on the scanner while having the opposite surface facing the scanner.

When the test booklet 600 illustrated in FIG. 14B is obtained, the CPU 11a obtains a distance between the first end portion 91 and the second end portion 92 of the test sheet PS forming the test booklet 600 to specify the quantity of displacement of the fold. Then, the CPU 11a subtracts the predetermined reference value from this distance to specify the quantity of displacement of the fold.

This reference value is the quantity of displacement originally produced between the first end portion 91 and the second end portion 92. In the present exemplary embodiment, this originally produced quantity of displacement is subtracted from this distance to specify the quantity of displacement of the fold.

More specifically, the CPU 11a analyses a read image serving as a captured image obtained by the scanner when it reads the test booklet 600, and specifies the distance between the first end portion 91 and the second end portion 92 of the test sheet PS forming the test booklet 600.

The CPU 11a then subtracts a predetermined reference value from the specified distance to specify the quantity of displacement of the fold.

The case described above is a case where the quantity of displacement of the fold is specified based on the positions of the two end portions of the test sheet PS forming the test booklet 600.

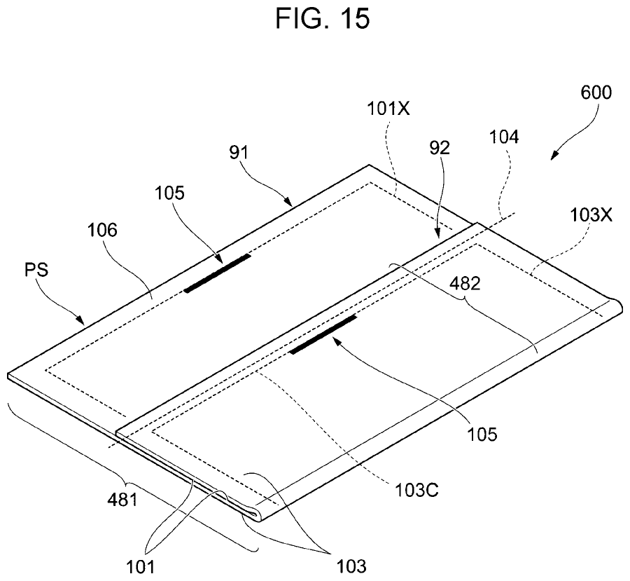

The method for specifying the quantity of displacement of the fold is not limited to this. For example, the quantity of displacement of the fold may be specified by forming, as illustrated in, for example, FIG. 15 (illustrating another example of the test booklet 600), a specifying image 105 serving as an image used to specify the quantity of displacement of the fold on each of the first surface 101 and the second surface 103 of the test sheet PS, and based on the position of the specifying image 105.

In other words, the specifying images 105 may be formed on both surfaces of the test sheet PS, and the quantity of displacement of the fold may be specified based on the positions of the specifying images 105.

More specifically, the quantity of displacement of the fold may be specified based on the position of one of the two specifying images 105 (see FIG. 15) that appears on either the first surface 93 (see FIG. 13B) or the second surface 94 of the test booklet 600.

The quantity of displacement of the fold may be specified based on the specifying images 105 formed on the first surface 101 and the second surface 103 of the test sheet PS instead of the positions of the first end portion 91 and the second end portion 92 of the test sheet PS.

When the quantity of displacement of the fold is to be specified based on the specifying image 105, the image forming apparatus 2 (see FIG. 1) forms the specifying image 105 on each of the first surface 101 and the second surface 103 of the test sheet PS.

More specifically, the image forming apparatus 2 forms the specifying image 105 on the first surface 101 of the test sheet PS within a predetermined rectangular image forming area 101X (see FIG. 15).

The image forming apparatus 2 inverts the test sheet PS, and also forms the specifying image 105 on the second surface 103 of the test sheet PS within a predetermined rectangular image forming area 103X.

Due to the structure of the image forming apparatus 2, the image forming unit 22 (see FIG. 1) is unable to form an image on the entireties of the first surface 101 and the second surface 103 of the test sheet PS. Thus, the image forming unit 22 forms the specifying images 105 within the rectangular image forming area 101X and the rectangular image forming area 103X that are smaller than the test sheet PS.

To specify the quantity of displacement of the fold, as in the above case, for example, the test sheet PS (see FIG. 14A) is folded at a position displaced to be closer to the second end portion 92 to expose the image forming area 101X of the first surface 101 (see FIG. 15) of the test sheet PS.

Thus, as illustrated in FIG. 15, the specifying image 105 formed within the image forming area 101X is exposed without being covered with the second-end-side portion 482.

In this case, when the test booklet 600 is viewed from a single surface of the test booklet 600, the exposed specifying image 105 is allowed to be visually checked.

In this case, when the scanner reads the test booklet 600 from the single surface of the test booklet 600, the specifying image 105 is included within the captured image obtained by the scanner when it reads the test booklet 600.

To fold the test sheet PS at a displaced position, the folding process is performed on the test sheet PS while at least part of the image forming area 103X of the second surface 103 of the test sheet PS is located on the single surface of the test booklet 600.

Thus, as illustrated in FIG. 15, the specifying image 105 formed on the second surface 103 of the test sheet PS is located on the single surface of the test booklet 600.

In this case, when the scanner reads the test booklet 600 from the single surface of the test booklet 600, the captured image obtained through this reading includes the specifying image 105 formed on the second surface 103 of the test sheet PS.

As described above, the captured image includes the specifying image 105 formed on the first surface 101 of the test sheet PS.

In an extreme case, when the test sheet PS is folded at, for example, a portion 104 in FIG. 15, the image forming area 103X of the second surface 103 of the test sheet PS is not located on the single surface of the test booklet 600.

More specifically, when the folding process is performed on the test sheet PS at a position closer to the second end portion 92 of the test sheet PS with respect to an end portion 103C of the image forming area 103X of the second surface 103, the image forming area 103X is not located on the single surface of the test booklet 600.

In this case, the specifying image 105 formed on the second surface 103 of the test sheet PS is not located on the single surface of the test booklet 600, and the scanner fails to read the specifying image 105.

To generate the test booklet 600, as described above, the test sheet PS is preferably folded at a position displaced from the center portion. Thus, the image forming area 101X of the first surface 101 of the test sheet PS is partially exposed without being covered with the second-end-side portion 482.

In this case, when an image is formed in the image forming area 101X, the image receiving portion where this image is formed is exposed without being covered with the second-end-side portion 482.

In this case, when the specifying image 105 is located in this image receiving portion, the specifying image 105 is left uncovered with the second-end-side portion 482, and thus the scanner is capable of reading the specifying image 105.

In the present exemplary embodiment, despite when increasing the quantity of displacement of the fold, the folding process is performed on the test sheet PS to allow part of the specific portion of the second surface 103 to be located at the second-end-side portion 482.

More specifically, the folding process is performed on the test sheet PS to allow the image receiving portion, where the image is formed, of the second surface 103 to be located at the second-end-side portion 482. Thus, the image receiving portion serving as this specific portion is located on the single surface of the test booklet 600.

In the present exemplary embodiment, despite when the test sheet PS is folded at a position displaced from the center portion of the test sheet PS to increase the quantity of displacement of the fold, part of the second surface 103 of the test sheet PS that is caused to be located on the outer side in the test booklet 600 as a result of the folding process is located at the second-end-side portion 482.

More specifically, in the present exemplary embodiment, part of the image forming area 103X of the second surface 103 of the test sheet PS is located at the second-end-side portion 482.

At this time, the image forming area 103X is regarded as an image receiving portion where the image is formed.

In the present exemplary embodiment, part of the image receiving portion of the second surface 103 that is caused to be located on the outer side in the test booklet 600 as a result of the folding process is located at the second-end-side portion 482.

Thus, when the specifying image 105 is located at this part of the image receiving portion of the second surface 103, the specifying image 105 is located at the second-end-side portion 482.

In the present exemplary embodiment, the folding process is performed while leaving the image receiving portion serving as an example of a specific portion of the first surface 101 of the test sheet PS uncovered with the second-end-side portion 482, and to allow the image receiving portion serving as an example of a specific portion of the second surface 103 of the test sheet PS to be located at the second-end-side portion 482.

In this case, both the image receiving portion located on the first surface 101 of the test sheet PS and the image receiving portion located on the second surface 103 of the test sheet PS are located on the single surface of the test booklet 600.

As illustrated in FIG. 15, in the present exemplary embodiment, each specifying image 105 is formed from an image of a straight line. Instead, each specifying image 105 may have any shape other than a straight line that allows its position to be detected.

In the present exemplary embodiment, as illustrated in FIG. 1, the image forming unit 22 serving as an image forming member is disposed upstream from the saddle stitching unit 44 serving as an example of a folding member in the direction of transporting the sheet P.

In the present exemplary embodiment, the image forming unit 22 forms an image on the first surface 101 of the test sheet PS (see FIG. 15) within the image forming area 101X.

As described above, the image forming unit 22 fails to form an image on the entire surface of the first surface 101 of the test sheet PS, and thus forms an image within the rectangular image forming area 101X that is smaller than the size of the test sheet PS.

In the present exemplary embodiment, the first surface 101 of the test sheet PS has, around the image forming area 101X, a no-image-formed area 106, or an annular area receiving no image. No image is formed in this no-image-formed area 106.

When the test sheet PS is folded at the center portion, the entirety of the image forming area 101X of the first surface 101 of the test sheet PS is located on the inner surface of the test booklet 600 generated through the folding process to be hidden.

Thus, in the present exemplary embodiment, as described above, the CPU 11a performs the folding process on the test sheet PS at a portion closer to the second end portion 92 with respect to the center portion to leave part of the image forming area 101X of the first surface 101 of the test sheet PS uncovered with the second-end-side portion 482.

Thus, the image formed within the image forming area 101X is exposed. When the specifying image 105 is formed within the image forming area 101X, the specifying image 105 is exposed.

In the present exemplary embodiment, as in the case of the first surface 101, the image forming unit 22 forms an image on the second surface 103 of the test sheet PS within the predetermined rectangular image forming area 103X. When forming the specifying image 105, the image forming unit 22 forms the specifying image 105 within the image forming area 103X.

When performing the folding process on the test sheet PS, the CPU 11a leaves part of the image forming area 101X of the first surface 101 of the test sheet PS uncovered with the second-end-side portion 482, and allows part of the image forming area 103X of the second surface 103 of the test sheet PS to be located at the second-end-side portion 482.

Thus, as described above, in this case, the specifying image 105 formed on the first surface 101 of the test sheet PS is located on the single one of the two surfaces of the test booklet 600, and the specifying image 105 formed on the second surface 103 of the test sheet PS is located on the single surface.

In this case, when the scanner reads the test booklet 600 while the test booklet 600 is placed on the scanner while having the single surface of the test booklet 600 facing the scanner, the scanner reads the two specifying images 105.

In this case, the captured image obtained by the scanner includes the specifying image 105 formed on the first surface 101 of the test sheet PS and the specifying image 105 formed on the second surface 103 of the test sheet PS.

In this case, the CPU 11a specifies the quantity of displacement of the fold based on the distance between these two specifying images 105 included in the captured image serving as a read image.

More specifically, in this case, the CPU 11a subtracts a predetermined reference quantity of displacement from this distance between the two specifying images 105 included in the captured image to specify the quantity of displacement of the fold.

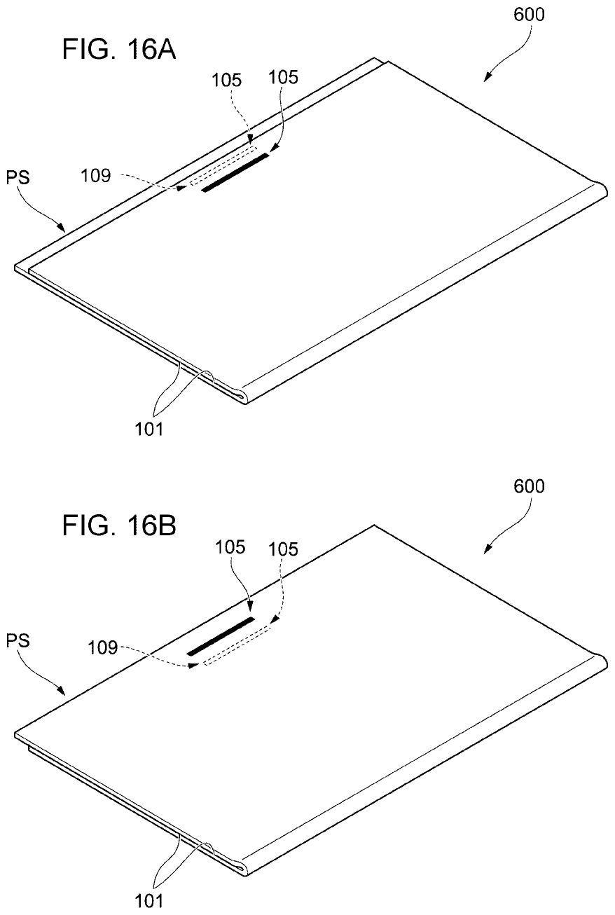

When the test sheet PS is to be folded at a position displaced from the center portion, and the quantity of displacement is small, as illustrated in FIGS. 16A and 16B (diagrams illustrating another example of a test booklet) with positions 109, the specifying image 105 formed on the first surface 101 of the test sheet PS may fail to be exposed.

Thus, when the test sheet PS is to be folded at a position displaced from the center portion, the quantity of displacement is to exceed the predetermined specific value.

When the quantity of displacement exceeds the predetermined specific value, the test booklet 600 illustrated in FIG. 15 is generated without causing the states illustrated in FIGS. 16A and 16B.

In the above description, the case where the quantity of displacement of the fold is specified based on the positions of the first end portion 91 and the second end portion 92 serving as the two end portions of the test sheet PS or based on the positions of the two specifying images 105 formed on the test sheet PS is described as an example.

The aspect of specifying the quantity of displacement of the fold is not limited to this. The quantity of displacement of the fold may be specified based on the position of the first end portion of the two end portions of the test sheet PS and the position of one specifying image 105 formed on the test sheet PS.

More specifically, for example, the quantity of displacement of the fold may be specified based on the position of the first end portion 91 (see FIG. 15) of the test sheet PS, and the position of the specifying image 105 located on the outer surface of the test booklet 600 at the second-end-side portion 482.

Alternatively, for example, the quantity of displacement of the fold may be specified based on the position of the second end portion 92 of the test sheet PS and the position of the specifying image 105 located on the inner surface of the test booklet 600 at the first-end-side portion 481.

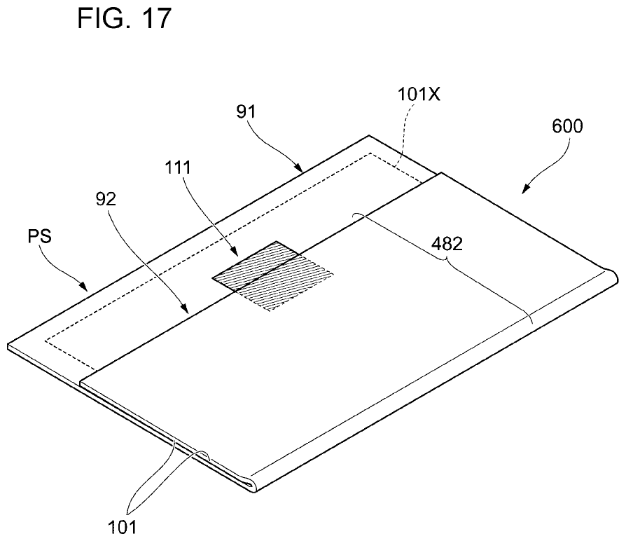

FIG. 17 is a diagram of another example of the test booklet 600.

As in the above case, this test booklet 600 is also folded at a position displaced from the center portion of the test sheet PS, and leaves part of the image forming area 101X of the first surface 101 of the test sheet PS uncovered with the second-end-side portion 482.

In this structure example, an image 111 with a color other than white is formed within the image forming area 101X at a portion located at the back of the second end portion 92 of the test sheet PS. More specifically, a solid image 111 with a color other than white is formed.

In this example, the quantity of displacement of the fold is specified based on the positions of the first end portion 91 and the second end portion 92 of the test sheet PS.

In this case, when the colored image 111 with a color other than white (hereafter, referred to as “a colored image 111”) is formed at a portion of the first surface 101 of the test sheet PS located at the back of the second end portion 92, the position of the second end portion 92 is more highly accurately detected. In this case, the quantity of displacement of the fold is specified with higher accuracy.

Here, the case where the colored image 111 is formed at the back of the second end portion 92, or the first end portion of the test sheet PS, to specify the positions of the two end portions is described.

In addition to this case, the colored image 111 may also be formed at the back of the end portion to specify the quantity of displacement of the fold based on the position of one end portion and the position of one specifying image 105 (not illustrated in FIG. 17).

Setting of Amount of Movement of to-be-Pressed Portion 443 Based on Other Information

In the above description, the distance by which at least one of the to-be-pressed portions 443 moves is set based on the quantity of displacement of the fold. Instead, the CPU 11a serving as an example of the processor may set the distance by which the to-be-pressed portion 443 moves based on other information.

More specifically, the CPU 11a may specify, for example, image information on an image formed on the sheet P constituting the sheet bundle, and set the distance by which the to-be-pressed portion 443 moves based on the image information.

More specifically, the CPU 11a may set the distance by which the to-be-pressed portion 443 moves based on the distribution of the image on the sheet P specified by the image information.

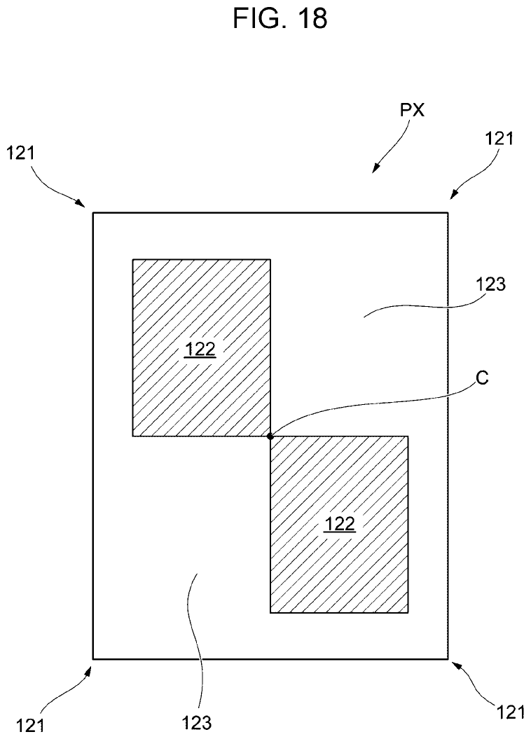

FIG. 18 illustrates one sheet P included in the sheet bundle that is to undergo the folding process, in the state of being located closest to the folding rollers 448 in FIG. 5A.

FIG. 18 illustrates the sheet P located closest to the folding rollers 448 when viewed in the direction of arrow XVIII in FIG. 5A.

In this example, images 122 are formed from toner on one sheet P (hereafter referred to as “a target sheet PX”) forming a sheet bundle at portions between a center portion C of the target sheet PX and two corners 121 having a diagonal relationship among four corners 121 of the target sheet PX.

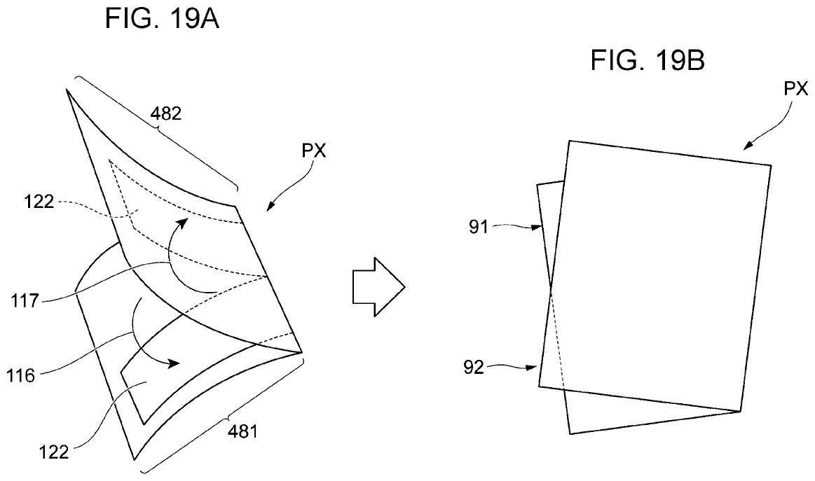

FIGS. 19A and 19B are diagrams of the target sheet PX illustrated in FIG. 18 in the state of being transported by the folding rollers 448 (see FIG. 5A) and in the state after the folding process.

More specifically, FIG. 19A is a diagram of the target sheet PX illustrated in FIG. 18 in the state of being transported by the folding rollers 448 (see FIG. 5A), and FIG. 19B is a diagram of the target sheet PX in the state after the folding process.

In actual transportation of the sheets P, second and subsequent sheets P follow this target sheet PX. However, FIGS. 19A and 19B omit illustration of the second and subsequent sheets P.

As illustrated in FIG. 18, when the images 122 are formed from toner between the center portion C of the target sheet PX and the two corners 121 of the target sheet PX, the frictional force that occurs between the target sheet PX and a second sheet P (not illustrated) located adjacent to the target sheet PX occurs in an unbalanced manner.

More specifically, in this case, the frictional force that occurs between the second sheet P and the target sheet PX at the two portions where the images 122 (refer to FIG. 18) are formed is small.

In contrast, the frictional force that occurs between the second sheet P and the target sheet PX at two portions 123 is large.

In this case, as illustrated in FIG. 19A, the moment of rotation in the direction of arrow 116 is exerted on the first-end-side portion 481 of the target sheet PX, and the moment of rotation in the direction of arrow 117 is exerted on the second-end-side portion 482 of the target sheet PX.

In this case, the target sheet PX after undergoing the folding process has a displaced fold as illustrated in FIG. 19B.

More specifically, the target sheet PX has a displaced fold formed due to the first end portion 91 and the second end portion 92 that are not parallel to each other.

In this processing example, to prevent a fold from being displaced, as described above, image information or information on an image formed on the sheet P forming a sheet bundle is specified, and the distance by which at least one of the to-be-pressed portions 443 moves is set based on this image information.

More specifically, as described above, the distance by which the to-be-pressed portion 443 moves is set based on the distribution of the images 122 on the target sheet PX specified by the image information.

More specifically, the distance by which the to-be-pressed portion 443 moves is set based on the distribution of the images 122 to move the to-be-pressed portion 443. More specifically, the positional relationship between the first edge-side portion 443A (see FIG. 6) and the second edge-side portion 443B is changed in the height direction.

More specifically, the positional relationship between the first edge-side portion 443A and the second edge-side portion 443B in the to-be-pressed portions 443 is changed to form a fold displaced in a direction opposite to the direction in which a displaced fold is formed due to the images 122.

Thus, the displaced fold formed due to the images 122 and the displaced fold formed due to the to-be-pressed portions 443 cancel out, and the displacement of the fold formed in the booklet is reduced.

When the images 122 specified by the image information are distributed to cause a moment of rotation that rotates the first-end-side portion 481 of the target sheet PX in one direction and that rotates the second-end-side portion 482 of the target sheet PX in the opposite direction, the CPU 11a sets the distance by which the to-be-pressed portion 443 moves to cause a fold displaced in a direction opposite to the direction of displacement caused due to this moment of rotation.

Thus, the displaced fold finally formed in the booklet is reduced.

More specifically, as illustrated in FIG. 18, when the images 122 are formed between the center portion C and an upper left one of the corners 121 of the target sheet PX and between the center portion C and a lower right one of the corners 121 of the target sheet PX, the CPU 11a sets the distance by which the to-be-pressed portions 443 move to locate the first edge-side portion 443A in the to-be-pressed portions 443 (see FIG. 6) higher than the second edge-side portion 443B.

In this case, the displaced fold formed due to the images 122 and the displaced fold formed due to the to-be-pressed portions 443 cancel out to reduce the displaced fold formed in the booklet.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A recording-medium processing apparatus, comprising:
a mobile body that supports a to-be-pressed portion against which a first end portion of a recording medium that is to undergo a folding process is pressed, the mobile body allowing the to-be-pressed portion to move relative to the mobile body; and
a moving mechanism that includes a driving source, and moves the to-be-pressed portion relative to the mobile body.
   (((2)))

The recording-medium processing apparatus according to (((1))), further comprising:
a processor configured to:
   set a distance of movement of the to-be-pressed portion,
wherein the processor is configured to set the distance of movement based on a quantity of displacement of a fold formed in a processed recording medium that is the recording medium subjected to the folding process after having the first end portion pressed against the to-be-pressed portion.
   (((3)))

The recording-medium processing apparatus according to (((2))),
wherein the processor is configured to:
   specify the quantity of displacement of the fold based on a captured image obtained by capturing an image of the processed recording medium; and
   set the distance of movement based on the quantity of displacement of the fold specified based on the captured image.
      (((4)))

The recording-medium processing apparatus according to (((1))), further comprising:
a processor configured to set a distance of movement of the to-be-pressed portion,
wherein the processor is configured to:
   obtain image information serving as information on an image formed on the recording medium; and
   set the distance of movement of the to-be-pressed portion based on the image information.
      (((5)))

The recording-medium processing apparatus according to (((4))),
wherein the processor is configured to set the distance of movement of the to-be-pressed portion based on distribution of an image on the recording medium specified by the image information.
   (((6)))

The recording-medium processing apparatus according to any one of (((1))) to (((5))),
wherein the driving source and the moving mechanism are disposed at the mobile body.
   (((7)))

The recording-medium processing apparatus according to (((6))),
wherein the mobile body includes an actuator that operates by receiving a driving force from the driving source to touch the recording medium, and
wherein the driving force is fed to both of the to-be-pressed portion and the actuator from the driving source used in common.
   (((8)))

The recording-medium processing apparatus according to (((7))),
wherein the moving mechanism includes a disconnector that disconnects the driving force transmitted from the driving source toward the to-be-pressed portion.
   (((9)))

The recording-medium processing apparatus according to any one of (((1))) to (((8))),
wherein the to-be-pressed portion includes a first edge-side portion against which a first edge portion of the first end portion of the recording medium in a longitudinal direction is pressed, and a second edge-side portion against which a second edge portion of the first end portion of the recording medium in the longitudinal direction is pressed, and
wherein the moving mechanism moves the to-be-pressed portion to change a positional relationship between the first edge-side portion and the second edge-side portion in a direction crossing the longitudinal direction.
   (((10)))

A recording-medium processing apparatus, comprising:
a folding member that performs a folding process on a recording medium including a first end portion, a second end portion, and a center portion at a portion located between the first end portion and the second end portion, and that generates a recording medium that includes a to-be-folded portion, a first-end-side portion located between the to-be-folded portion and the first end portion, and a second-end-side portion located between the to-be-folded portion and the second end portion; and
a processor configured to perform the folding process on the recording medium at a position closer to the second end portion with respect to the center portion, and to leave a specific portion of a first surface of the recording medium caused to be located on an inner side as a result of the folding process uncovered with the second-end-side portion.
   (((11)))

The recording-medium processing apparatus according to (((10))),
wherein the processor is configured to leave an image receiving portion serving as a portion of the first surface receiving an image uncovered with the second-end-side portion.
   (((12)))

The recording-medium processing apparatus according to (((11))),
wherein the processor is configured to perform the folding process to leave the specific portion of the first surface uncovered with the second-end-side portion and to allow a specific portion of a second surface of the recording medium caused to be located on an outer side as a result of the folding process to be located at the second-end-side portion.
   (((13)))

The recording-medium processing apparatus according to (((12))),
wherein the processor is configured to perform the folding process to allow a portion of the second surface receiving an image to be located at the second-end-side portion.
   (((14)))

The recording-medium processing apparatus according to (((10))), further comprising:
an image forming member that forms an image on the first surface of the recording medium within a predetermined image forming area upstream from the folding member in a direction in which the recording medium is transported,
wherein the processor is configured to allow part of the image forming area of the first surface uncovered with the second-end-side portion.
   (((15)))

The recording-medium processing apparatus according to (((14))),
wherein the image forming member forms an image on a second surface of the recording medium within a predetermined image forming area, and
wherein the processor performs the folding process to leave part of the image forming area of the first surface uncovered with the second-end-side portion and to allow part of the image forming area of the second surface caused to be located on an outer side as a result of the folding process to be located at the second-end-side portion.
   (((16)))

An image forming system, comprising:
an image forming apparatus that forms an image on a recording medium; and
a recording-medium processing apparatus that performs a process on the recording medium on which the image is formed by the image forming apparatus,
wherein the recording-medium processing apparatus includes the recording-medium processing apparatus according to any one of (((1))) to (((15))).

What is claimed is:

1. A recording-medium processing apparatus, comprising:
a mobile body that supports a to-be-pressed portion against which a first end portion of a recording medium that is to undergo a folding process is pressed, the mobile body allowing the to-be-pressed portion to move relative to the mobile body; and
a moving mechanism that includes a driving source, and moves the to-be-pressed portion relative to the mobile body.

2. The recording-medium processing apparatus according to claim 1, further comprising:
a processor configured to:
set a distance of movement of the to-be-pressed portion,
wherein the processor is configured to set the distance of movement based on a quantity of displacement of a fold formed in a processed recording medium that is the recording medium subjected to the folding process after having the first end portion pressed against the to-be-pressed portion.

3. The recording-medium processing apparatus according to claim 2,
wherein the processor is configured to:
specify the quantity of displacement of the fold based on a captured image obtained by capturing an image of the processed recording medium; and
set the distance of movement based on the quantity of displacement of the fold specified based on the captured image.

4. The recording-medium processing apparatus according to claim 1, further comprising:
a processor configured to set a distance of movement of the to-be-pressed portion,
wherein the processor is configured to:
obtain image information serving as information on an image formed on the recording medium; and
set the distance of movement of the to-be-pressed portion based on the image information.

5. The recording-medium processing apparatus according to claim 4,
wherein the processor is configured to set the distance of movement of the to-be-pressed portion based on distribution of an image on the recording medium specified by the image information.

6. The recording-medium processing apparatus according to claim 1,
wherein the driving source and the moving mechanism are disposed at the mobile body.

7. The recording-medium processing apparatus according to claim 6,
wherein the mobile body includes an actuator that operates by receiving a driving force from the driving source to touch the recording medium, and
wherein the driving force is fed to both of the to-be-pressed portion and the actuator from the driving source used in common.

8. The recording-medium processing apparatus according to claim 7,
wherein the moving mechanism includes a disconnector that disconnects the driving force transmitted from the driving source toward the to-be-pressed portion.

9. The recording-medium processing apparatus according to claim 1,
wherein the to-be-pressed portion includes a first edge-side portion against which a first edge portion of the first end portion of the recording medium in a longitudinal direction is pressed, and a second edge-side portion against which a second edge portion of the first end portion of the recording medium in the longitudinal direction is pressed, and
wherein the moving mechanism moves the to-be-pressed portion to change a positional relationship between the first edge-side portion and the second edge-side portion in a direction crossing the longitudinal direction.

10. A recording-medium processing apparatus, comprising:
a folding member that performs a folding process on a recording medium including a first end portion, a second end portion, and a center portion at a portion located between the first end portion and the second end portion, and that generates a recording medium that includes a to-be-folded portion, a first-end-side portion located between the to-be-folded portion and the first end portion, and a second-end-side portion located between the to-be-folded portion and the second end portion; and
a processor configured to perform the folding process on the recording medium at a position closer to the second end portion with respect to the center portion, and to leave a specific portion of a first surface of the recording medium caused to be located on an inner side as a result of the folding process uncovered with the second-end-side portion.

11. The recording-medium processing apparatus according to claim 10,
wherein the processor is configured to leave an image receiving portion serving as a portion of the first surface receiving an image uncovered with the second-end-side portion.

12. The recording-medium processing apparatus according to claim 11,
wherein the processor is configured to perform the folding process to leave the specific portion of the first surface uncovered with the second-end-side portion and to allow a specific portion of a second surface of the recording medium caused to be located on an outer side as a result of the folding process to be located at the second-end-side portion.

13. The recording-medium processing apparatus according to claim 12,
wherein the processor is configured to perform the folding process to allow a portion of the second surface receiving an image to be located at the second-end-side portion.

14. The recording-medium processing apparatus according to claim 10, further comprising:
an image forming member that forms an image on the first surface of the recording medium within a predetermined image forming area upstream from the folding member in a direction in which the recording medium is transported,
wherein the processor is configured to allow part of the image forming area of the first surface uncovered with the second-end-side portion.

15. The recording-medium processing apparatus according to claim 14,
wherein the image forming member forms an image on a second surface of the recording medium within a predetermined image forming area, and
wherein the processor performs the folding process to leave part of the image forming area of the first surface uncovered with the second-end-side portion and to allow part of the image forming area of the second surface caused to be located on an outer side as a result of the folding process to be located at the second-end-side portion.

16. An image forming system, comprising:
an image forming apparatus that forms an image on a recording medium; and
a recording-medium processing apparatus that performs a process on the recording medium on which the image is formed by the image forming apparatus,
wherein the recording-medium processing apparatus includes the recording-medium processing apparatus according to claim 1.
